(19) United States
(12) Patent Application Publication
(10) Pub. No.: US 2006/0098660 A1
(43) Pub. Date: May 11, 2006

(54) Mechanism for automatic protection switching and apparatus utilizing same

(76) Inventors: Rajesh Pal, Hamden, CT (US); Eric Ferguson, Madison, CT (US)

Correspondence Address: GORDON & JACOBSON, P.C., 60 LONG RIDGE ROAD, SUITE 407, STAMFORD, CT, 06902, US

(21) Appl. No.: 10/985,546

(22) Filed: Nov. 10, 2004

(51) Int. Cl. H04L 12/56; H04L 12/28

(52) U.S. Cl. 370/395.51

(57) ABSTRACT

An automatic protection switching circuit for a SONET network element is realized in part by dedicated hardware logic together with a programmed processor. The dedicated hardware logic includes: a first part adapted to extract fault codes carried in predetermined overhead bytes that are part of an ingress signal; a second part adapted to generate fault codes that represent inter-module communication errors within the node; a third part that determines switch fabric configuration updates based upon the fault codes generated by the first block and the second block; and a fourth part that communicates with switch fabric control logic to carry out the switch fabric configuration updates determined by the third block. The programmed processor automatically configured and controls the first, second, third and fourth parts in accordance with software executing thereon to carry out a selected one of a plurality of automatic protecting switching schemes. The dedicated hardware logic also preferably includes logic that automatically forwards K-bytes in pass-thru mode for BLSR ring protection schemes.

### BACKGROUND OF THE INVENTION

1. Field of the Invention

This invention relates broadly to transport-level redundancy schemes in a network. More particularly, this invention relates to automatic protection switching (APS) in a SONET/SDH transport network.

2. State of the Art

The Synchronous Optical Network (SONET) or the Synchronous Digital Hierarchy (SDH), as it is known in Europe, is a common telecommunications transport scheme which is designed to accommodate both DS-1 (T1) and E1 traffic as well as multiples (DS-3 and E-3) thereof. A DS-1 signal consists of up to twenty four time division multiplexed DS-0 signals plus an overhead bit. Each DS-0 signal is a 64 kb/s signal and is the smallest allocation of bandwidth in the digital network, i.e. sufficient for a single telephone connection. An E1 signal consists of up to thirty-two time division multiplexed DS-0 signals with at least one of the DS-0s carrying overhead information.

Developed in the early 1980s, SONET has a base (STS-1) rate of 51.84 Mbit/sec in North America. The STS-1 signal can accommodate 28 DS-1 signals or 21 E1 signals or a combination of both. The basic STS-1 signal has a frame length of 125 microseconds (8,000 frames per second) and is organized as a frame of 810 octets (9 rows by 90 byte-wide columns). It will be appreciated that 8,000 frames*810 octets per frame*8 bits per octet=51.84 Mbit/sec. Higher rate signals (STS-N, STS-Nc) are built from the STS-1 signal, while lower rate signals are subsets of the STS-1 signal. The lower rate components of the STS-1 signal, commonly known as virtual tributaries (VT) or tributary units (TU), allow SONET to transport rates below DS3, which is used for example to provide Ethernet-Over-SONET (EOS) transport services, Packet-Over-SONET transport services, frame relay transport services, etc.

In Europe, the base (STM-1) rate is 155.520 Mbit/sec, equivalent to the North American STS-3 rate (3*51.84=155.520). The STS-3 (STM-1) signals can accommodate 3 DS-3 signals or 63 E1 signals or 84 DS-1 signals, or a combination of them. The STS-12 (STM-4) signals are 622.080 Mbps and can accommodate 12 DS-3 signals, etc. The STS-48 (STM-16) signals are 2,488.320 Mbps and can accommodate 48 DS-3 signals, etc. The highest defined STS signal, the STS-768 (ATM-256) is nearly 40 Gbps (gigabits per second). The abbreviation STS stands for Synchronous Transport Signal and the abbreviation STM stands for Synchronous Transport Module. STS-N signals are also referred to as Optical Carrier (OC-N) signals when transported optically rather than electrically.

The STS-1 signal is organized as frames, each having 810 bytes, which includes transport overhead and a Synchronous Payload Envelope (SPE). The SPE includes a payload, which is typically mapped into the SPE by what is referred to as path terminating equipment at what is known as the path layer of the SONET architecture. Line terminating equipment places an SPE into a frame, along with certain line overhead (LOH) bytes. The LOH bytes provide information for line protection and maintenance purposes. The section layer in SONET transports the STS-N frame over a physical medium, such as optical fiber, and is associated with a number of section overhead (SOH) bytes. The SOH bytes are used for framing, section monitoring, and section level equipment communication. Finally, a physical layer transports the bits serially as either electrical or optical entities.

The SPE portion of an STS-1 frame is contained within an area of an STS-1 frame that is typically viewed as a matrix of bytes having 87 columns and 9 rows. Two columns of the matrix (30 and 59) contain fixed stuff bytes. Another column contains STS-1 POH. The payload of an SPE may have its first byte anywhere inside the SPE matrix, and, in fact may move around in this area between frames. The method by which the starting payload location is determined is responsive to the contents of transport overhead bytes in the frame referred to as H1 and H2. H1 and H2 store an offset value referred to as a “pointer”, indicating a location in the STS-1 frame in which the first payload byte is located.

The pointer value enables a SONET network element (NE) to operate in the face of a plesiochronous network where clock rates of different network elements may differ slightly. In such a case, as data is received and transmitted, data may build up in a buffer of a network element if the output data rate is slower than the incoming data rate, and an extra byte may need to be transmitted in what is known as a negative justification opportunity byte. Conversely, where the output data rate is greater than the incoming data rate, one less byte may be transmitted in the STS-l frame (i.e., a positive justification). These justification operations cause the location of the beginning of the payload of the STS-1 frame to vary.

Various digital signals, such as those defined in the well-known Digital Multiplex Hierarchy (DMH), may be included in the SPE payload. The DMH defines signals including DS-0 (referred to as a 64-kb/s time slot), DS-1 (1.544 Mb/s), and DS-3 (44.736 Mb/s). The SONET standard is sufficiently flexible to allow new data rates to be supported, as services require them. In a common implementation, DS-1s are mapped into virtual tributaries (VTs), which are in turn multiplexed into an STS-1 SPE, and are then transported over an optical carrier.

It is also becoming commonplace to transport other digital data signals (such as ATM cells, GFP frames, Ethernet frames, etc) as part of the SPE payload of the STS-1 signal by mapping such signals into virtual tributaries, which are in turn multiplexed into STS-1 SPE(s), which are then transported over an optical carrier. Virtual concatenation may be used whereby the virtual tributaries are fragmented and distributed among multiple SPE(s) yet maintained in a virtual payload container. There are four different sizes of virtual tributaries, including VT1.5 having a data rate of 1.728 Mbit/sec, VT2 at 2.304 Mbits/sec, VT3 at 3.456 Mbit/sec, and VT6 at 6.912 Mbit/sec. The alignment of a VT within the payload of an STS-1 frame is indicated by a pointer within the STS-1 frame.

As mentioned above, SONET provides substantial overhead information. SONET overhead information is accessed, generated, and processed by the equipment which terminates the particular overhead layer. More specifically, section terminating equipment operates on nine bytes of section overhead, which is found in the first three rows of columns 1 through 9 of the SPE. The section overhead is used for communications between adjacent network elements and supports functions such as performance monitoring, local orderwire, data communication channels (DCC) to carry information for OAM&P, and framing.

Line terminating equipment operates on line overhead, which is found in rows 4 to 9 of columns 1 through 9 of the SPE. The line overhead supports functions such as locating the SPE in the frame, multiplexing or concatenating signals, performance monitoring, line maintenance, and line-level automatic protection switching (APS) as described below in detail.

Path overhead (POH) is associated with the path layer, and is included in the SPE. The Path overhead, in the form of either VT path overhead or STS path overhead, is carried from end-to-end. VT path overhead (VT POH) terminating equipment operates on the VT path overhead bytes starting at the first byte of the VT SPE, as indicated by the VT payload pointer. VT POH provides communication between the point of creation of a VT and its point of disassembly. VT path overhead supports functions such as performance monitoring of the VT SPE, signal labels (the content of the VT SPE, including status of mapped payloads), VT path status, and VT path trace. STS path terminating equipment operates on the STS path overhead (STS POH) which starts at the first byte of the STS SPE. STS POH provides for communication between the point of creation of an STS SPE and its point of disassembly. STS path overhead supports functions such as performance monitoring of the STS SPE, signal labels (the content of the STS SPE, including status of mapped payloads), STS path status, STS path trace, and STS path—level automatic protection switching as described below in detail.

SONET/SDH networks employ redundancy and Automatic Protection Switching (APS) features that ensure that traffic is switched from a working channel to a protection channel when the working channel fails. In order to minimize the disruption of customer traffic, SONET/SDH standards require that the protection switching must be completed in less than 50 milliseconds.

Various types of redundancy may be designed into a SONET network. Some examples are illustrated in the discussion that follows.

FIG. 1 shows a point-to-point redundancy scheme. Point-to-point redundancy focuses on the behavior of a pair of nodes 11A, 11B that are coupled together by a plurality of SONET lines 13₁, 13₂, 13₃ . . . 13_{X-1}, 13_{X}. Although other point-to-point schemes may be possible, common point-to-point schemes typically include 1+1 and 1:N. Both schemes classify a SONET line as either a working line or a protection line. A working line is deemed as the “active” line that carries the information transported by the network. A protection line serves as a “back-up” for a working line. That is, if a working line fails (or degrades), the protection line is used to carry the working line's traffic.

In a 1+1 scheme, both the working and protection lines simultaneously carry the same traffic. For example, consider the architecture of FIG. 1 wherein line 13₁ is the working line and line 13₂is the protection line for the transmission of signals by node 11A. In this configuration, the transmitting node 11A simultaneously transmits the same information on both the working line 13₁ and the protection line 13₂. The receiving node 11B, during normal operation, “looks to” the working line 13₁ for incoming traffic and ignores the incoming traffic on the protection line 13₂. If a failure or degradation of the working line 13₁ is detected, the receiving node 11B simply “looks to” the protection line 13₂ for the incoming traffic (rather than the working line 13₁).

In a 1:N scheme, one protection line backs up N working lines (where N is an integer from 1 to 14). For example, referring to FIG. 1, lines 13₁ through 13_{X-1} are the working lines while line 13_{X} is the protection line for the transmission of signals from node 11A. In this configuration, if any of the working lines 13₁ through 13_{X-1} fail or degrade, the transmitting node 11A sends the traffic which would normally be transported over the failed/degraded working line over the protection line 13_{X}. The receiving node 11B also “looks to” the protection line 13_{X} for the traffic that would have been sent over the failed/degraded working line prior to its failure/degradation.

FIGS. 2A-4B illustrate various ring redundancy schemes. Ring redundancy focuses on the behavior of a plurality of nodes coupled together in a ring. There are two types of protection switching used in SONET rings: path protection switching and line protection switching. A path switched ring utilizes the SONET path overhead information (e.g., path alarm indication signal, path loss of pointer) to trigger the restoration of individual end-to-end paths (e.g., VTs and/or STS-1s) using automatic protection switching actions. Because protection switching is performed at the path layer, protection switching decisions for a specific path are independent of any other path's status. A line switched ring utilizes the SONET line overhead information (e.g., K1 and K2 bytes) to effectuate automatic protection switching actions. Unlike path protection switching, line protection switching restores all paths traversing the line using the principle of line-level signal loop-back onto the protection ring or channel group. Three ring architectures have been adopted as SONET standards, including a Unidirectional Path Switched Ring (UPSR) architecture, a 4-line bidirectional line switched ring (BLSR/4), and a 2-line bidirectional line switched ring (BLSR/2).

FIGS. 2A and 2B illustrate the UPSR architecture which includes a 2-line unidirectional ring employing path protection switching based on the concept of 1+1 protection as described above. The nodes of the ring (for example, the four add-drop multiplexers (ADMs) shown as 15A, 15B, 15C, 15D) are coupled together via working line segments 17A, 17B, 17C, 17D (collectively, working line 17) and via corresponding protection line segments 19A, 19B, 19C, 19D (collective, protection line 19). During normal operation as shown in FIG. 2A, duplicate copies of the signal are inserted at the entry node (typically referred to as “head-end node”) on both the working and protection lines. This is commonly referred to as a “head-end bridge”. The signal is received at the exit node (or “tail-end node”) and dropped from the ring. When the primary signal is lost or degraded (for example, due to a cable cut through working line section 17A and protection line section 19A), a path selector performs a “tail-end switch” to the protection line as shown in FIG. 2B. Since demand in a path switched ring is managed at the SONET path layer, protection switching decisions are made individually for each path (e.g., VT, STS-1) rather than for the entire line.

FIGS. 3A and 3B illustrate the BLSR/4 architecture. The nodes of the ring (for example, the five ADMs shown as 21A, 21B, 21C, 21D, 21E) are coupled together via separate line pairs for working and protection demands. The working line segments 23A₁, 23B₁, 23C₁, 23D₁, 23E₁ collectively form a working line 23₁ that transports working demand in the clockwise direction, while the working line segments 25A₁, 25B₁, 25C₁, 25D₁, 25E₁ collectively form a working line 25₁ that transports working demand in the counter-clockwise direction. Similarly, the protection line segments 23A₂, 23B_{21, 23C}₂, 23D₂, 23E₂ collectively form a protection line 23₂ that transports protection demand in the clockwise direction, while the protection line segments 25A₂, 25B₂, 25C₂, 25D₂, 25E₂ collectively form a protection line 25₂ that transports protection demand in the counter-clockwise direction. Unlike UPSR, the working demands transported on working lines 23₁ and 25₁ are not permanently bridged to the corresponding protection lines 23₂ and 25₂. Instead, service is restored by looping back the working demand from the working lines 23₁ and 25₁ to the protection lines 23₂ and 25₂ at the nodes adjacent the failed segment as shown in FIG. 3B. A failed segment may include a span, a node or a number of spans and nodes. In the event of a node failure, the nodes adjacent the failed node perform such loop-back operations and also squelch the working and protection demand that is to be dropped by the failed node, if any.

Since protection switching is performed at both nodes adjacent the failure, communication is required between these nodes in order to coordinate the protection switch. The two byte APS message channel (bytes K1 and K2) in the SONET line overhead performs this function. Because the protection lines may pass through one or more intermediate nodes before reaching their destination, addressing is required to ensure that the APS message is recognized at the proper node and protection switching is initiated at the correct pair of nodes. For this purpose, the SONET BLSR standard reserves four bits in the K1 byte for the destination node's ID and four bits in the K2 byte for the originating node's ID. Details of the failure message communication in the APS message channel between the nodes of the ring to effectuate the desired protection switching is set forth in detail in U.S. Pat. No. 5,442,620, herein incorporated by reference in its entirety. In order to accomplish squelching, each node on the ring stores a ring map and a squelch table. The ring map includes the node ID values, which are four bit words that are uniquely assigned to the nodes of the ring and included in the K1 and K2 bytes of the APS message channel. The squelch table contains, for each STS signal (or VT signal) that is incoming or outgoing at the given node, information that identifies the node where the STS signal (or VT signal) is added onto the ring and the node where the STS signal (or VT signal) is dropped from the ring. The ring map and squelch tables for the nodes of the ring are typically generated at a workstation, and communicated to one of the nodes on the ring to which the workstation is operably coupled. This node distributes the ring map and squelch tables to the other nodes on the ring through an inband communication channel (such as a DCC channel) between the nodes on the ring.

FIGS. 4A and 4B illustrate the BLSR/2 architecture. The nodes of the ring (for example, the five ADMs shown as 31A, 31B, 31C, 31D, 31E) are coupled together via a line pair that transports both working and protection demands. The segments 32A, 32B, 32C, 32D, 32E transport both working and protection demands in a clockwise direction around the ring whereby working demands are transported over working channel groups while protection demands are transported over protection channel groups. Similarly, the segments 34A, 34B, 34C, 34D, 34E transport both working and protection demands in a counter-clockwise direction around the ring whereby working demands are transported over working channel groups while protection demands are transported over protection channel groups. More particularly, half of the STS-1 channels are reserved for working demand and the other half are reserved for protection. The BLSR/2 architecture operates in a manner similar to the BLSR/4 architecture; however, in the event of a failure, the working channel group is looped back onto the protection channel group at each node adjacent the failure as shown in FIG. 4B. In the event of a node failure, the nodes adjacent the failed node perform such loop-back operations and also squelch the working and protection channel demand that is to be dropped by the failed node, if any. The time slots for the working demands at the intermediate nodes are not affected by the fault.

Current APS implementations are typically realized in software executing on a central processor. The SONET/SDH framing device on the line card reports status and error conditions to a co-located processor. The line-card processor communicates status and error condition data to the central processor over a communication channel, which is typically a standard processor channel such as Ethernet. The central processor collects the status data and error condition data communicated thereto from the line cards, analyzes the data to determine if protection switching is required, and downloads a new configuration setting to a switching fabric to complete the APS action.

In a large system, the number of line cards and the demands issued by such line cards impose a high bandwidth requirement on the communication channel between the line cards and the central processor and also impose a heavy processing burden on the central processor. These requirements disadvantageously increase the complexities and costs of the line card and central processing subsystem.

Therefore, there is a need in the art to provide an improved mechanism for carrying out automatic protection switching (APS) in a SONET/SDH network in a manner that does not impose additional bandwidth requirements between the line card and the central decision-making function processing point. The APS mechanism must also effectively meet the bandwidth and computational requirements for large systems at reasonable costs.

### SUMMARY OF THE INVENTION

It is therefore an object of the invention to provide a mechanism for carrying out automatic protection switching (APS) in a SONET/SDH network in a manner that does not impose additional bandwidth requirements between line cards and a central decision-making function processing point. The APS mechanism must also effectively meet the bandwidth and computational requirements for large systems at reasonable costs.

It is another object of the invention to provide an APS mechanism that effectively meets the bandwidth and computational requirements for large systems at reasonable costs.

In accord with these objects, which will be discussed in detail below, an APS circuit for a network element that receives and transmits SONET signals is realized in part by dedicated hardware logic together with a programmed processor. The dedicated hardware logic includes: a first part that is adapted to extract fault codes carried in predetermined overhead bytes that are part of an ingress signal; a second part that is adapted to generate fault codes that represent inter-module communication errors within the node; a third part that determines switch fabric configuration updates based upon the fault codes generated by the first block and the second block; and a fourth part that communicates with switch fabric control logic to carry out the switch fabric configuration updates determined by the third block. The programmed processor is adapted to automatically configure and control the first, second, third and fourth parts in accordance with software executing on the programmed processor to carry out a selected one of a plurality of automatic protecting switching schemes (e.g., point-to-point 1+1, point-to-point 1:N, UPSR, BLSR/4, BLSR/2) configured by operation of the programmed processor. The dedicated hardware logic also preferably includes K-byte forwarding logic that automatically forwards K-bytes in pass-thru mode for BLSR ring protection schemes.

It will be appreciated that the functionality realized by the dedicated hardware blocks (fault processing, switch fabric update, K-byte processing, etc.) can be readily adapted to meet the bandwidth and computational requirements for large systems at reasonable costs. The software-based processing system provides for programmability and user control over the operations carried out by the dedicated hardware, for example providing for user-initiated commands that override the automatic protection switching operation that would be normally carried out by the dedicated hardware. In addition, the APS circuitry supports the communication of fault information between the line interface(s) of the network elements and the APS circuitry over an inband overhead byte communication channel, thereby imposing no additional bandwidth requirements between the line interface unit(s) and the central decision-making point.

According to one embodiment of the invention, the dedicated hardware is realized by an FPGA, ASIC, PLD, or transistor-based logic and possibly embedded memory for system-on-chip applications.

According to another embodiment of the invention, the dedicated hardware preferably includes block(s) that perform K-byte processing/forwarding as well as inband communication of ring map and squelch table information to thereby support BLSR schemes.

Additional objects and advantages of the invention will become apparent to those skilled in the art upon reference to the detailed description taken in conjunction with the provided figures.

### BRIEF DESCRIPTION OF THE DRAWINGS

FIG. 1 is a block diagram of a point-to-point architecture for a SONET/SDH network.

FIGS. 2A and 2B are block diagrams of a unidirectional path switched ring (UPSR) architecture for a SONET/SDH network; FIG. 2A illustrates normal operations of the UPSR; and FIG. 2B illustrates operations during automatic protection switching of the UPSR.

FIGS. 3A and 3B are block diagrams of a 4-line bidirectional line switched ring (BLSR/4) architecture for a SONET/SDH network; FIG. 3A illustrates normal operations of the BLSR/4; and FIG. 3B illustrates operations during automatic protection switching of the BLSR/4.

FIGS. 4A and 4B are block diagrams of a 2-line bidirectional line switched ring (BLSR/2) architecture for a SONET/SDH network; FIG. 4A illustrates normal operations of the BLSR/2; and FIG. 4B illustrates operations during automatic protection switching of the BLSR/2.

FIGS. 5A, 5B and 5C are block diagrams of a SONET Network Element in accordance with the present invention, which can be configured for use as one or more nodes in a point-to-point 1+1 redundancy scheme or a UPSR scheme; FIG. 5A illustrates the system level architecture of the Network Element; FIG. 5B is a functional block diagram of the SONET Uplink Interfaces of FIG. 5A; and FIG. 5C is a functional block diagram of the Switch Card of FIG. 5A.

FIG. 6 is a block diagram of a SONET Network Element in accordance with the present invention, which can be configured for use as one or more nodes in a BLSR/4 scheme.

FIG. 7 is a block diagram of a SONET Network Element in accordance with the present invention, which can be configured for use as one or more nodes in a BLSR/2 scheme.

FIG. 8 is a functional block diagram of exemplary protection switching operations carried out by the hardware-based fault processing block and programmed processor of FIG. 5B.

FIG. 9 is a functional block diagram of exemplary protection switching operations carried out by the hardware-based fault processing block, hardware-based K-byte processing block, hardware-based switch fabric update block, and the programmed processor of FIG. 5C.

FIG. 10 is an illustration of the logical organization of a selector table entry utilized by the auto-source selector logic block of FIG. 9 in automatic determination of switch fabric configuration updates in accordance with fault codes dynamically supplied thereto.

### DETAILED DESCRIPTION OF THE PREFERRED EMBODIMENTS

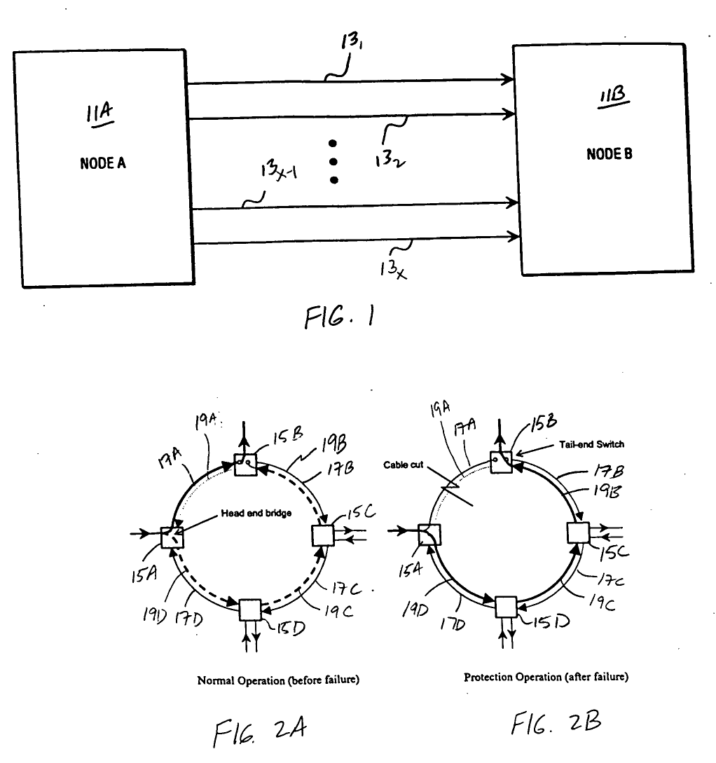

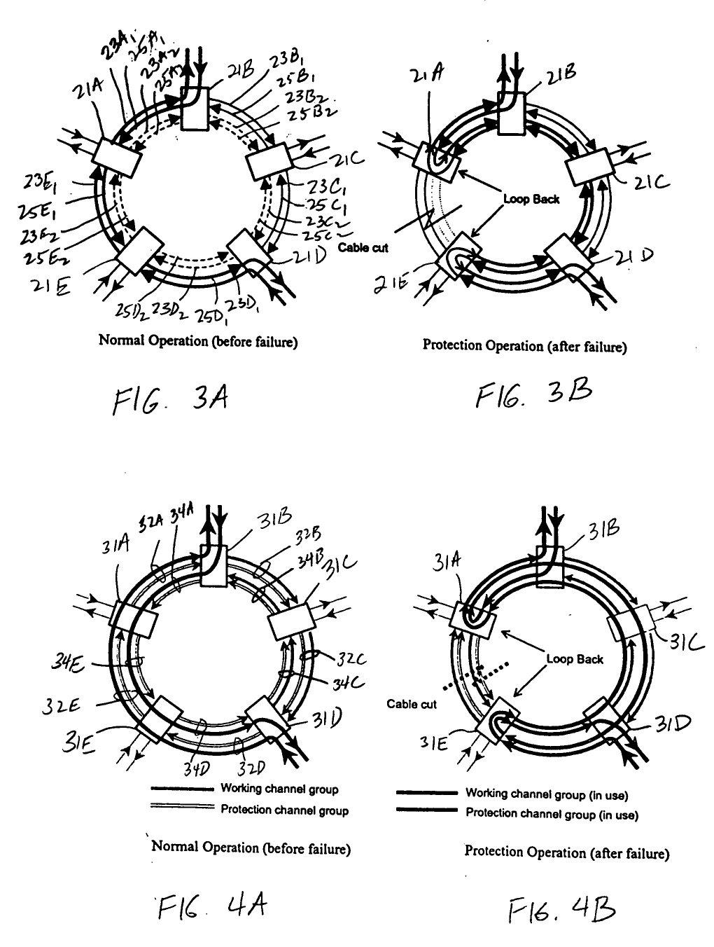

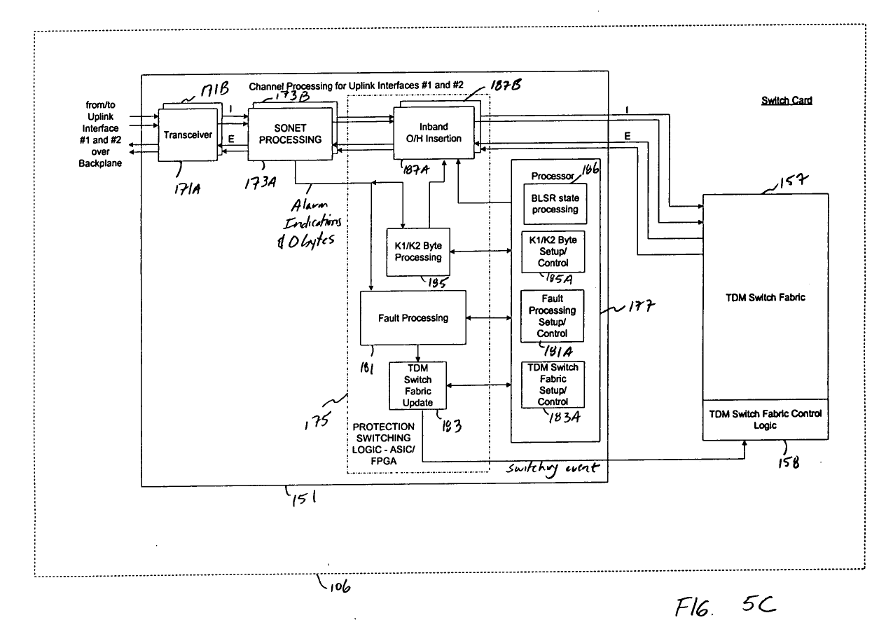

Turning now to FIG. 5A, a SONET Network Element 100 in accordance with the present invention includes a set of SONET Uplink interfaces 102A, 102B and a set of Tributary interfaces 104 that are interconnected to a switch unit 106 across a backplane 108. The SONET Uplink interfaces 102A, 102B may support various SONET media line interfaces, such as OC-3, OC-12, OC-48, OC-192 or any other suitable interface. The SONET media line interfaces may utilize separate optical fibers to carry the signals between network elements and/or may utilize wavelength division multiplexing components (such as course wavelength division multiplexing (CWDM) components or dense wavelength division multiplexing (DWDM) components) that carry the signals between network elements over distinct wavelengths on a optical fiber. The SONET Uplink interface 102A is operably coupled to a working receive (W Rx) OC-N communication link and a working transmit (W Tx) OC-N communication link, while the SONET Uplink interface 102B is operably coupled to a protection receive (P Rx) OC-N communication link and a protection transmit (P Tx) OC-N communication link. In this manner, the network element can be configured to support a 1+1 Point-to-Point Protection Switching scheme as described above with respect to FIG. 1 or a UPSR ring protection scheme as described above with respect to FIGS. 2A and 2B. The functionality of the Network element can be readily expanded to support other linear APS schemes such as 1:N Point-to-Point Protection Switching schemes.

As shown in FIG. 5B, the SONET uplink interfaces 102A, 102B include a physical layer interface 121 which typically performs optical-to-electrical conversion for the Rx optical signals supplied thereto and electrical-to-optical conversion for Tx optical signals generated therefrom. These electrical signals are operated on/generated by a SONET Framer 123 that performs SONET overhead processing and path monitoring operations on the incoming and outgoing signals. Such operations include byte alignment and framing, descrambling (Section TOH/RSOH processing), maintenance signal processing (including signal failure and degrade alarm indications with respect to incoming signals), control byte processing and extraction (Line TOH/MSOH processing and maintenance signal processing), pointer tracking, and retiming (clock recovery and synchronization of paths).

The line-level and path-level signal failure and degrade alarm indications (e.g., system failure, Loss of Signal (LOS), Out of Frame Alignment (OOF), Loss of Frame (LOF), Alarm Indication Signal-Line (AIS-L), Alarm Indication Signal-Path (AIS-P)) identified by the SONET framer 123 are monitored by protection switching circuitry. The protection switching circuitry, which is realized in part by dedicated hardware logic 125 together with a programmed processing device 127, includes a fault processing block 129 that translates the signal fail and degrade alarm conditions that pertain to a given incoming STS-1 signal to an appropriate fault code. An inband overhead insertion block 131 inserts these fault codes into unused overhead transport bytes (preferably, all of the timeslots of byte D10) in the same STS-1 signal. The STS-1 signal, which carries the inband code faults, is supplied to a transceiver 133 as part of ingress signals that are communicated to the switch card 106 over the backplane 108. The dedicated hardware 125 may be realized by a field-programmable gate array (FPGA), a programmable logic device (PLD), and application-specific-integrated-circuit (ASIC) or other suitable device(s). In system-on-a-chip applications, the dedicated hardware 125 may be realized by transistor-based logic and possibly embedded memory that is integrally formed with other parts of the Uplink interface, such as the physical layer interface 121, SONET framer 123, the programmed processor 127, and/or the transceiver 133.

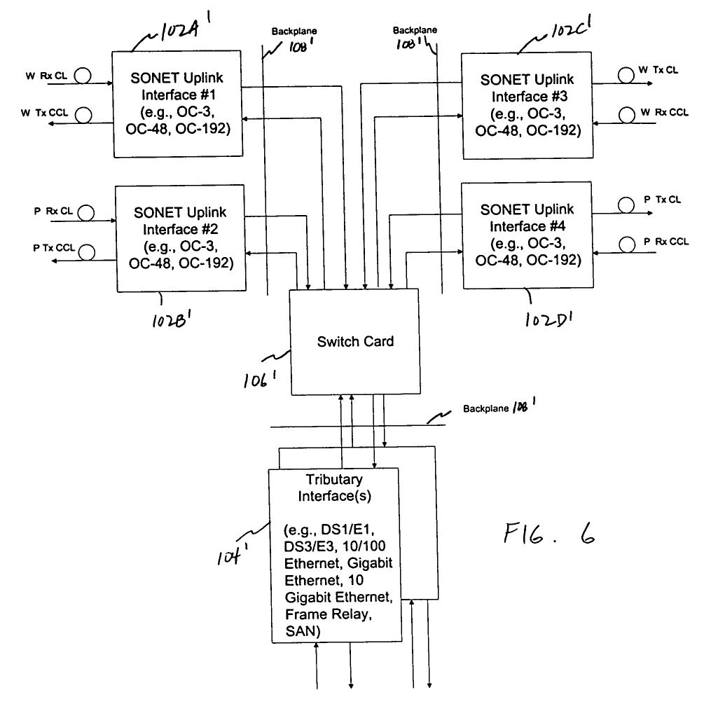

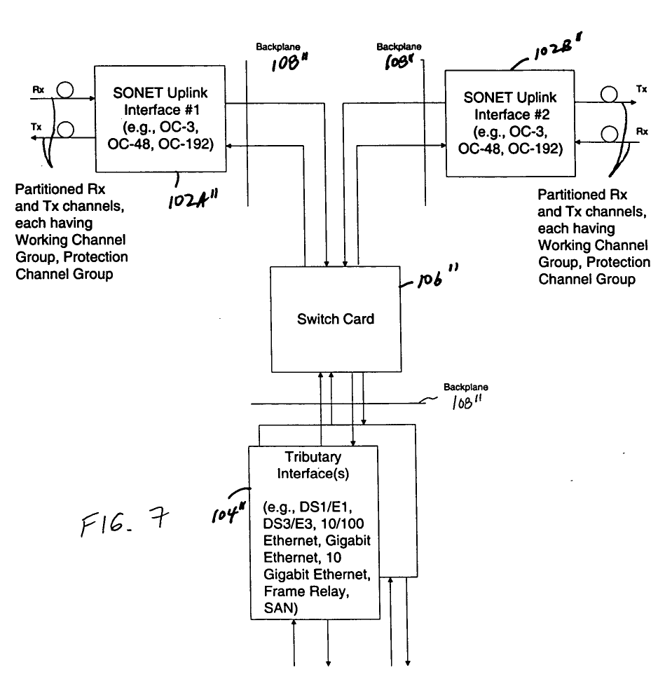

The transceiver 133 reproduces egress signals that are communicated from the switch card over the backplane 108. The dedicated hardware logic 125 of the protection switching circuit includes inband overhead processing logic 135 that monitors these egress signals, and extracts predetermined overhead bytes (for example, certain time slots in the D11 bytes) in an STS-1 signal that is part of the egress signal. These predetermined overhead bytes are used as an inband communication channel to communicate BLSR state information from the switch card 106 to the SONET uplink interface. Such BLSR state information is communicated to the processing device 127, which processes the BLSR state information supplied thereto to carry out advanced configuration operations, such as automatic payload configuration as described below. Such inband overhead byte processing operations are not relevant to the 1+1 redundancy scheme or the UPSR redundancy scheme supported by the configuration of FIG. 5A, and thus can be disabled by the programmed processor 127 for this configuration. However, such operations are used to support the BLSR/4 and BLSR/2 as described below with respect to FIGS. 6 and 7, and thus are enabled by the programmed processor 127 for these configurations. In addition, similar overhead byte processing operations are required to support dynamic path configuration for a point-to-point 1:N protection scheme as described herein.

Automatic payload configuration is a process by which the path-level configuration parameters (most importantly, the SPE configuration) of a SONET line are changed automatically. This process is particularly important in BLSR rings where, the configuration of the paths on the protect lines change dynamically once the working traffic is placed on them. Typically, the “idle” state configuration of the protect paths are all STS-1s, forcing P-UNEQ. However, on a protection switch, the protect path configuration changes to match that of the working paths. Such changes are accomplished utilizing BLSR state codes. When paths are configured on working lines of a BLSR node, this configuration is duplicated to all “protect” SONET uplink interfaces with a particular index (BLSR state code) associated with it. Upon initiation of the protection switch, the processor 177 on the switch card utilizes the inband communication channel (for example, certain time slots in the D11 bytes) to inform the “head-end protect” SONET uplink interface and the “tail-end protect” SONET uplink interface to configure the paths associated with a given BLSR state code. BLSR nodes, which are designated as pass-thru, mimic this communication in both incoming and outgoing direction so that traffic can be forwarded correctly around the ring on the protect paths. The reason why this configuration cannot be hard-coded at initialization time is because of the highly dependent on the working path configuration of the nodes adjacent to the failure (which, of course, is not determined until switch time).

Dynamic state information can also be utilized to support a point-to-point 1:N redundancy scheme as described herein. In such a scheme, there is no “BLSR state” configured on these lines; however, a similar mechanism of dynamic path configuration is required for the paths on the protect line at the time of the switch.

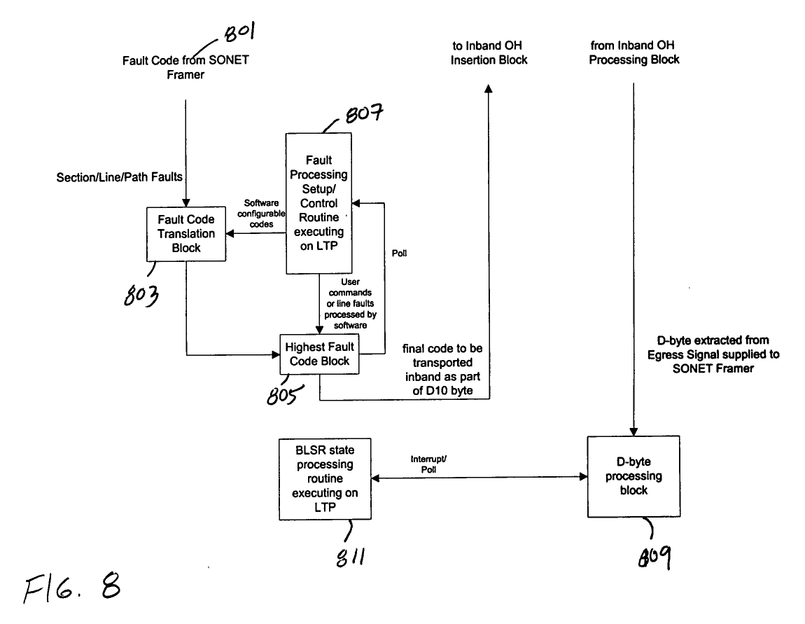

Detailed descriptions of exemplary protection switching processing operations carried out by the dedicated logic circuit 125 and processor 127 to support a number of redundancy schemes (including point-to-point 1+1, UPSR, BLSR/4, BLSR/2) are set forth below with respect to FIG. 8.

The Tributary Interfaces 106 may support various DMH signal line formats (such as DS1/E1 and/or DS3/E3), SONET STS-N signals, and possibly other digital communication formats such as 10/100 Ethernet, Gigabit Ethernet, 10 Gigabit Ethernet, Frame Relay, and SAN/Fiber Channel.

For Tributary Interfaces that support DMH signal line formats, the incoming DMH signals are typically mapped into virtual tributaries, which are in turn multiplexed into STS-1 SPE(s) (or possibly a higher order signal or other suitable format). Electrical signals representing this STS-1 signal (or possibly a higher order signal or other suitable format signal) are part of ingress signals communicated from the Tributary interface to the switch card 106 over the backplane 108. The outgoing DMH signals are typically demultiplexed from electrical signals representing an STS-1 signal (or possibly a higher order signal or other suitable format signal) that are part of egress signals communicated from the switch card 106 to the Tributary interface over the backplane 108.

For Tributary Interfaces that support STS-N signal line formats, SONET line processing operations are performed on incoming and outgoing signals. The incoming signals are possibly multiplexed into a higher order signal and then converted into suitable electrical signals, which are forwarded as part of the ingress signals to the switch card 106 over the backplane 108. The outgoing signals are typically reproduced from electrical signals communicated as part of the egress signals from the switch card 106 over the backplane 108.

For Tributary interfaces that handle digital communication formats (such as 10/100 Ethernet, Gigabit Ethernet, 10 Gigabit Ethernet, Frame Relay, and SAN/Fiber Channel), link layer processing is performed that frames the received data stream. The data frames are encapsulated (or possibly aggregated at layer 2) and then mapped into VTs of one or more STS-1 signals (or possibly a higher order STS-N signal or other suitable format signal). De-mapping, de-encapsulation and link layer processing operations are carried out that reproduce the appropriate data signals from electrical signals communicated as egress signals from the switch card 106 via the backplane 108.

The link layer processing and mapping operations may be performed as part of the Tributary interface 104. Alternatively, the link layer processing and mapping operations may be carried out by tributary channel processing circuitry that is integral to the switch card 108. Such link layer and mapping operations are typically realized by a data engine that performs link layer processing that frames the received data stream and encapsulation (or possibly aggregation at layer 2) of the frames. VC/LCAS circuitry maps the encapsulated frames into VTs of one or more STS-1 signals (or possibly a higher order STS-N signal or other suitable format signal), which is communicated to the time-division-multiplexed switch fabric of the switch card 106. The encapsulation/de-encapsulation operations performed by the data engine preferably utilize a standard faming protocol (such as HLDC, PPP, LAPS, or GFP), and the mapping/de-mapping operations performed by the VC/LCAS circuitry preferably utilize virtual concatenation and a link capacity adjustment scheme in order to provide service level agreement (SLA) processing of customer traffic. Moreover, for IP data, the data engine may implement a routing protocol (such as MPLS and the psuedowire protocol) that embeds routing and control data within the frames encapsulated with the VTs of the STS-1 signal (or higher order signal or other suitable format signal). Such routing and control data is utilized downstream to effectuate efficient routing decisions within an MPLS network.

As shown in FIG. 5C, the switch card 106 includes line channel processing circuitry 151 that receives the ingress signals communicated from the SONET uplink interfaces 102A, 102B, respectively. The line channel processing circuitry 151 includes transceiver blocks 171A, 171B and SONET signal processing blocks 173A, 173B for each uplink interface. The SONET signal processing blocks 173A, 173B interface to protection switching circuitry, which is realized in part by dedicated hardware logic 175 together with a programmed processor 177. The dedicated hardware 175 may be realized by a field-programmable gate array (FPGA), a programmable logic device (PLD), and application-specific-integrated-circuit (ASIC) or other suitable device(s). In system-on-a-chip applications, the dedicated hardware 175 may be realized by transistor-based logic and possibly embedded memory that is integrally formed with other parts of the switch card, such as the transceiver blocks 171A, 171B, the SONET signal processing blocks 173A, 173B, the TDM switch fabric 157, the programmed processor 177, and/or parts of the line channel processing circuitry 151 and/or the tributary channel processing circuitry (not shown).

The transceiver blocks 171A, 171B reproduce ingress signals communicated from their corresponding Uplink interface, and passes the ingress signals to the correspond SONET signal processing blocks 173A, 173B. The SONET signal processing blocks 173A, 173B perform SONET overhead processing and monitoring operations on the ingress signals supplied thereto. Such operations include byte alignment and framing, descrambling (Section TOH/RSOH processing), maintenance signal processing (including signal failure and degrade alarm indications with respect to incoming signals), control byte processing and extraction (Line TOH/MSOH processing and maintenance signal processing), pointer tracking, and retiming (clock recovery and synchronization of paths). The section-level failure and degrade alarm indications (e.g., system failure, Loss of Signal (LOS), Out of Frame Alignment (OOF), Loss of Frame (LOF), B1 error—Signal Fail, B1 error—Signal Degrade) identified by the SONET signal processing circuitry 173 together with the certain overhead transport bytes (e.g., all ingress D bytes) extracted from the STS-1 signal that is part of the ingress signals are passed to a Fault Processing block 181.

The Fault Processing block 181 monitors the signal fail and degrade alarm conditions supplied by the SONET signal processing blocks 173A, 173B as well as portions of the overhead transport bytes (e.g., all of the timeslots of the D10 byte) supplied by the SONET signal processing blocks 173A, 173B to identify “local” faults and “remote” faults encoded by such data. Note that “local” faults are caused by inter-module synchronization problems and other internal failures that might occur within the network element 100 itself, while “remote” faults are faults in the lines between nodes. The Fault Processing block 181 generates “local” and “remote” fault codes that represent such faults, and analyzes the remote and local fault codes to identify the appropriate protection switching configuration based upon the configuration of the network element and the local and remote fault codes. The generation of the “local” and “remote” fault codes is preferably accomplished by translation of the alarm data and/or overhead byte data supplied by the SONET processing blocks 173A, 173B into normalized fault codes such that the protection switching circuitry is independent of the vendor of the SONET processing blocks 173A, 173B. “Local” faults are preferably translated into fault codes that are equivalent to line-level faults for all lines configured on a given inter-card interface. In the UPSR configuration, line faults are preferably converted to path-based equivalents (e.g., P-AIS codes). In addition, the fault codes are preferably organized in a hierarchical manner with lower priority fault codes and higher priority fault codes. The fault code analysis operations preferably utilize the higher priority fault codes for the basis of the protection switching operations. Moreover, it is preferable that the processor 177 includes a fault processing setup/control routine 181A that configures the fault processing operations carried out by the block 181 and also provides for software-based operations that override the faults codes generated by block 181 during such analysis. This configuration can be readily adapted to allow a user to initiate and command desired protection switching operations.

The switch fabric 157 includes a plurality of input ports that are selectively connected to one or more of a plurality of output ports by switch fabric control logic 158. STS-1 ingress signals are presented to the input ports of the switch fabric 157 in a time-division-multiplexed manner where they are connected to the appropriate output port to thereby output STS-1 egress signals for supply to one of the Uplink Interfaces or one of the Tributary interfaces (not shown) as desired.

In the event that a protection switch is to be made, the Fault Processing block 181 cooperates with switch fabric update logic 183 to generate a switching event signal, which is communicated to switch fabric control logic 158 to effectuate an update to the connections made by the switch fabric 157 in accordance with the desired switching operation. Moreover, it is preferable that the processor 177 include a switch fabric control routine 183A that configures the switch fabric update operations carried out by the block 183 (for example, by configuring one or more timers associated with such update operations) and also provides for software-based operations which can override the switch fabric updates automatically carried out by block 183. This configuration can be readily adapted to allow a user to initiate and command desired protection switching operations.

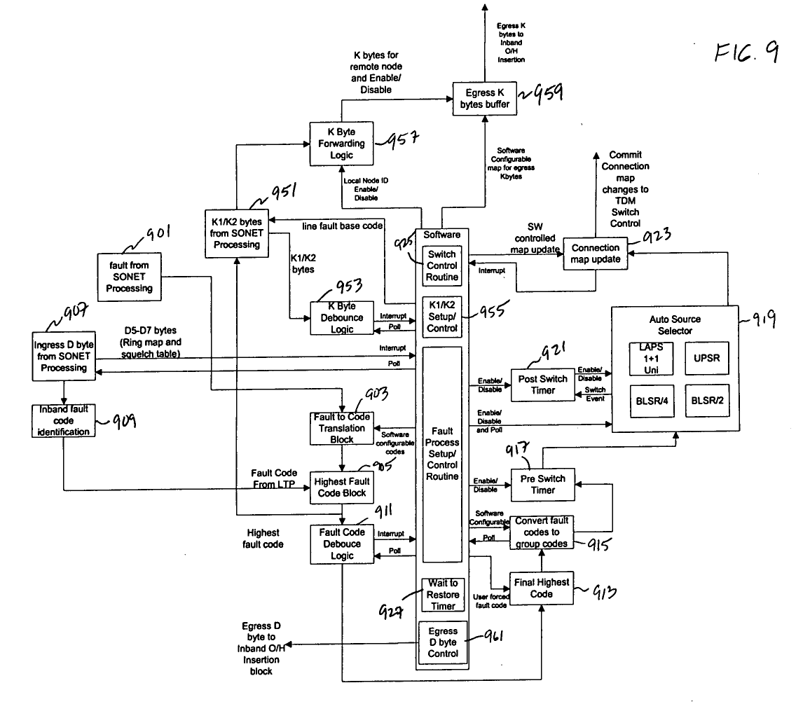

Detailed descriptions of exemplary protection switching operations carried out by the dedicated logic circuit 175 and processor 177 to support a number of redundancy schemes (including point-to-point 1+1, point-to-point 1:N, UPSR, BLSR/4, BLSR/2) are set forth below with respect to FIG. 9.

The configuration shown in FIG. 5A can be used to realize the nodes in either a point-to-point 1+1 redundancy scheme or a UPSR ring. An expanded version of the configuration of FIG. 5A can be used to realize the nodes in a point-to-point 1:N redundancy scheme. In these configurations, in the event that a line fault occurs as described above, the protection switching circuitry 125, 127 of the SONET uplink interface 102A which is integral to the node adjacent the failure and receives the working Rx signal under normal conditions, will detect a signal failure and insert the appropriate fault code into the unused overhead transport bytes (e.g., timeslots of the D10 byte) of the STS-1 signal communicated as part of an ingress signal to the switch card 106. The protection switching circuitry 175/177 that is integral to the switch card 106 will recover the “remote fault code(s)” from the overhead bytes.

The SONET signal processing blocks 173A, 173B also detect faults that are related to the link between the uplink interfaces and the switch card 106 over the backplane 108, which are referred to as “local” faults. The protection switching circuitry 175, 177 will generate “remote” and “local” fault codes that represent such faults, and analyze the “remote” and “local” fault codes in order to automatically determine that a protection switch is required by such codes. When it is determined that a protection switch is to be made, switch fabric update logic 183 automatically generates a switching event signal, which is communicated to switch fabric control logic 158 to effectuate an update to the connections made by the switch fabric 157 in accordance with the desired protection switching operation.

In the point-to-point 1+1 redundancy configuration, when the protection switch is required, the switch fabric update logic 183 cooperates with the switch fabric control logic 158 to automatically connect the “protection” ingress signal, which is generated by the channel processing for the second uplink interface in this configuration, to the appropriate output port during those time slots that are assigned the “working” ingress signal during normal operation. Similar automatic switching operations are performed in a point-to-point 1:N protection switching configuration.

In the UPSR redundancy configuration, when the protection “tail-end switch” is required (i.e., a signal failure on a particular “working” ingress signal path is identified and the Network Element is configured as the tail-end node that drops this particular path from the UPSR ring), the switch fabric update logic 183 cooperates with the switch fabric control logic 158 perform the required “tail-end switch” during those time periods assigned the “working” ingress signal path during normal operation. In this switching operation, the switch fabric update logic 183 and switch fabric control logic 158 automatically connects the “protection” ingress signal for the failed path, which is generated by the line channel processing for the second Uplink Interface, to the appropriate output port of the switch fabric. In the UPSR configuration, line faults are converted to path-based equivalents (e.g., P-AIS codes).

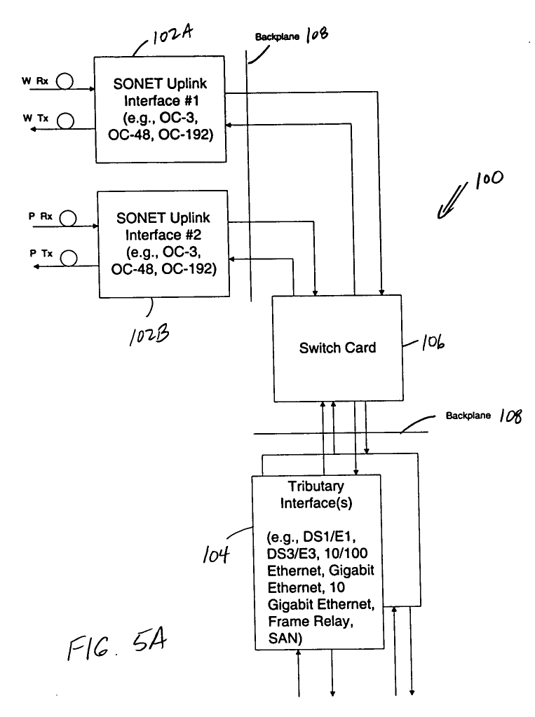

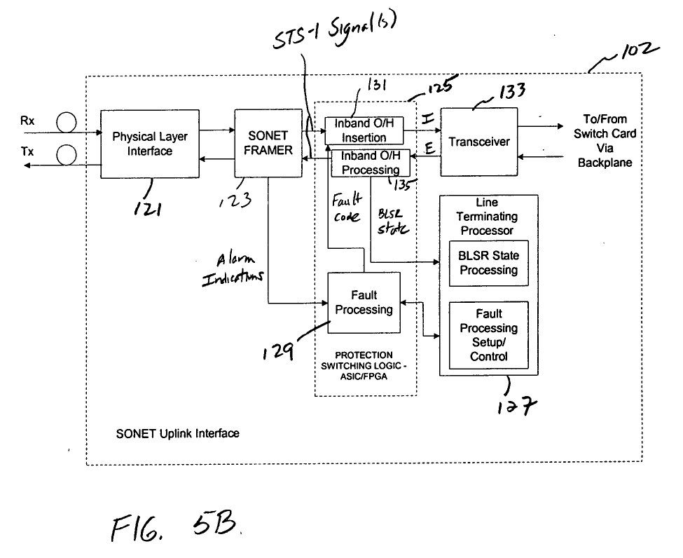

In order to support BLSR protection schemes as shown above in FIGS. 3A, 3B, 4A, 4B and described below with respect to FIGS. 6 and 7, the SONET signal processing blocks 173A, 173B of FIG. 5C extract K1/K2 transport overhead bytes for the STS-1 signal that is part of the ingress signals supplied thereto. These K1/K2 overhead bytes are supplied to K-byte processing logic 185, which is part of the dedicated logic circuit 175. In the absence of section-level or line-level faults (which is preferably dictated by a fault code signal supplied to the K-byte processing logic 185 by the Inband Fault Processing logic 181), the K-byte Processing logic 185 forwards the received K bytes to Inband O/H insertion logic 187 that inserts the K-bytes into the appropriate time slots in the egress signals supplied to the SONET Uplink interfaces. Preferably, the forwarding operation of the K-byte Processing logic 185 is enabled by software executing on the processor 177 to support K-byte pass-thru for BLSR ring protection schemes. Note that detailed descriptions of exemplary K-byte forwarding operations carried out by the protection switching circuitry are set forth below with respect to FIG. 9.

The Fault Processing block 181 also monitors other portions of the overhead transport bytes (e.g., timeslots 7-12 of the D5 byte, timeslots 7-12 of the D6 byte, and timeslots 7-12 of the D7 byte). These bytes are used as an inband communication channel to communicate the ring map and squelch tables for the network elements of the ring. The Fault processing block 181 communicates such bytes to the processor 177 (preferably utilizing an interrupt and polling interface). The processor 177 stores and updates the ring map and squelch table for the network element. This information is used to configure the fault processing and K-byte processing operations carried out by blocks 181 and 185 as described above.

In order to support BLSR protection, the processor 177 also executes a BLSR state processing routine 186. Upon initiation of a protection switch, the BLSR state processing routine 186 cooperates with the inband overhead insertion block 187 to communicate over an inband communication channel (for example, certain time slots in the D11 bytes) to inform the “head-end protect” SONET uplink interface and the “tail-end protect” SONET uplink interface to thereby configure the paths associated with a given BLSR state code. These uplink interfaces will recover such BLSR state information and utilize the BLSR state information to perform advanced configuration operations, such as automatic payload configuration as described herein.

For a point-to-point 1:N redundancy scheme, the processor 186 may be adapted to communicate dynamic path configuration data to the appropriate uplink interfaces for the paths on the protect line at the time of the switch. In this configuration, the uplink interface recovers the path configuration data and uses it to facilitate the appropriate action.

For redundancy purposes, the node may utilize redundant switch cards. In such a configuration, the processor 177 of the switch card 106 may be adapted to communicate a “Do-Not-Listen” (DNL) bit over an inband communication channel to the appropriate uplink interface. The DNL bit provides an indication that the uplink interface should select data from the other switch card.

Turning now to FIG. 6, there is shown a configuration of a Network Element that can be used for one or more of the nodes of a BLSR/4 ring. The Network Element includes a set of SONET Uplink interfaces 102A′, 102B′, 102C′, 102D′ and a set of Tributary interfaces 104′ that are interconnected to a switch unit 106′ across a backplane 108′. The SONET Uplink interfaces 102A′, 102B′, 102C′ and 102D′ may support various SONET media line interfaces, such as OC-3, OC-12, OC-48, OC-192 or any other suitable interface. The SONET media line interfaces may utilize separate optical fibers to carry the signals between network elements and/or may utilize wavelength division multiplexing components (such as course wavelength division multiplexing (CWDM) components or dense wavelength division multiplexing (DWDM) components) that carry the signals between network elements over distinct wavelengths on a optical fiber. The SONET Uplink interface 102A′ is operably coupled to a working receive clockwise (W Rx CL) OC-N communication link and a working transmit counter-clockwise (W Tx CCL) OC-N communication link. Similarly, SONET Uplink interface 102C′ is operably coupled to a working receive counter-clockwise (W Rx CCL) OC-N communication link and a working transmit clockwise (W Tx CL) OC-N communication link. The SONET Uplink interface 102B′ is operably coupled to a protection receive clockwise (P Rx CL) OC-N communication link and a protection transmit counter-clockwise (P Tx CCL) OC-N communication link. Similarly, SONET Uplink interface 102D′ is operably coupled to a protection receive counter-clockwise (P Rx CCL) OC-N communication link and a protection transmit clockwise (P Tx CL) OC-N communication link. In this manner, the network element can be configured to support a BLSR/4 Protection Switching scheme as described above with respect to FIGS. 3A and 3B.

In the configuration of FIG. 6, the Uplink Interfaces 102A′ 102B′, 102C′, and 102D′, the Tributary interface(s) 104′ and the Switch Card 106′ employ the same general architecture and functionality as described above with respect to FIGS. 5A-5C; yet the functionality of the switch card 106′ is expanded to include additional channel processing circuitry for the two additional Uplink interfaces. In the event that a line fault occurs as described above with respect to FIGS. 3A and 3B, the protection switching circuitry of the SONET uplink interface for the network elements adjacent the fault, which receives the failed working Rx signal, will detect a signal failure and insert the appropriate fault code into the unused overhead transport bytes (e.g., timeslots of the D10 byte) of the STS-1 signal communicated as part of an ingress signal to the switch card 106′. The protection switching circuitry that is integral to the switch card 106′ for that network element will recover the “remote” fault from the overhead bytes. The protection switching circuitry will generate a “remote” fault code that represents this remote fault as well as “local” fault codes, analyze the “remote” and “local” fault codes, and generate K1 and K2 bytes for APS channel communication around the ring in the direction opposite the fault. The protection switching circuitry also analyzes received K1/K2 bytes to ascertain if it in fact adjacent the fault. If so, the protection switching circuitry automatically determines that the loop-back protection switching operation is to be made, and the switch fabric update logic 183 cooperates with the switch fabric control logic 158 to effectuate an update to the connections made by the switch fabric 157 in accordance with the desired switching operation.

In the BLSR/4 redundancy configuration, when the protection switch is required, the switch fabric 157 for each network element adjacent the fault is automatically controlled to loop back the operational “working” ingress signal to the output port corresponding to the “protection” egress signal that is transported in the opposite direction while also looping back the “protection” ingress signal that is transported in the same direction as the operational “working” ingress signal to the output port corresponding to the “working” egress signal that is transported in the opposite direction. These loop-backs are illustrated in FIG. 3B. In the event of a failure of a network element, the network elements adjacent the failed network element perform such loop-back operations and also squelch the working and protection ingress signal demand that is to be dropped by the failed network element, if any. These operations are performed on a per-line basis and thus are performed for all paths that correspond to the failed line. In order to allow the network elements of the ring to determine whether a given network element is adjacent the detected fault, the network elements adjacent the failure originate APS messages, which are forwarded by the other network elements around the ring in a well know manner as set forth in U.S. Pat. No. 5,442,620 to Kremer, herein incorporated by reference in its entirety. The network elements utilize the ring map to identify that an incoming APS message pertains to a failed segment or node adjacent thereto. If this condition is satisfied, the appropriate loop-back and possibly squelching operations are performed. If not, the APS message is forwarded on to the adjacent network element in the ring.

In order to support the BLSR/4 protection scheme, the SONET signal processing blocks of the switch card 106′ extract K1/K2 transport overhead bytes for the STS-1 signal that is part of the ingress signals supplied thereto. In the absence of section-level or line-level faults, the K-byte Processing logic of the switch card 106′ forwards the received K bytes to Inband O/H insertion logic that inserts the K-bytes into the appropriate time slots in the egress signals supplied to the SONET uplink interfaces. Preferably, the forwarding operation of the K-byte Processing logic is enabled by software executing on the processor 177 of the switch card to support K-byte pass-thru for BLSR ring protection schemes. Note that detailed descriptions of exemplary K-byte forwarding operations carried out by the protection switching circuitry are set forth below with respect to FIG. 9.

The Fault Processing block of the switch card 106′ also monitors other portions of the overhead transport bytes (e.g., timeslots 7-12 of the D5 byte, timeslots 7-12 of the D6 byte, and timeslots 7-12 of the D7 byte). These bytes are used as an inband communication channel to communicate the ring map and squelch tables for the network elements of the ring. The processor 177 stores and updates the ring map and squelch table for the network element. This information is used to configure the fault processing and K-byte processing operations as described above.

In order to support BLSR/4 protection, the processor 177 of the switch card 106′ also executes a BLSR state processing routine that carries out advanced configuration operations, such as automatic payload configuration as described herein.

For redundancy purposes, the node may utilize redundant switch cards. In such a configuration, the processor 177 of the switch card 106′ may be adapted to communicate a “Do-Not-Listen” (DNL) bit over an inband communication channel to the appropriate uplink interface. The DNL bit provides an indication that the SONET uplink interface should select data from the other switch card.

Turning now to FIG. 7, there is shown a configuration of a Network Element that can be used for one or more of the nodes of a BLSR/2 ring. The Network Element includes a set of SONET Uplink interfaces 102A″ and 102B″ and a set of Tributary interfaces 104″ that are interconnected to a switch unit 106″ across a backplane 108″. The SONET Uplink interfaces 102A″, 102B″ may support various SONET media line interfaces, such as OC-3, OC-12, OC-48, OC-192 or any other suitable interface. The SONET media line interfaces may utilize separate optical fibers to carry the signals between network elements and/or may utilize wavelength division multiplexing components (such as course wavelength division multiplexing (CWDM) components or dense wavelength division multiplexing (DWDM) components) that carry the signals between network elements over distinct wavelengths on a optical fiber. The SONET Uplink interface 102A′ is operably coupled to a receive (Rx) OC-N communication link and a transmit (Tx) OC-N communication link. Similarly, the SONET Uplink interface 102B′ is operably coupled to a receive (Rx) OC-N communication link and a transmit (Tx) OC-N communication link. The Rx link of interface 102A″ and the TX link of Interface 102B′ transport both working and protection demands in a clockwise direction around the ring whereby working demands are transported over working channel groups while protection demands are transported over protection channel groups. Similarly, the Tx link of interface 102A″ and the Rx link of Interface 102B″ transport both working and protection demands in a counter-clockwise direction around the ring whereby working demands are transported over working channel groups while protection demands are transported over protection channel groups In this manner, the network element can be configured to support a BLSR/2 Protection Switching scheme as described above with respect to FIGS. 4A and 4B.

In the configuration of FIG. 7, the Uplink Interfaces 102A″, 102B″, the Tributary interface(s) 104″ and the Switch Card 106″ employ the same general architecture and functionality as described above with respect to FIGS. 5A-5C; yet the functionality of the switch card 106″ is expanded to include additional channel processing circuitry for the two additional Uplink interfaces. In the event that a line fault occurs as described above with respect to FIGS. 4A and 4B, the protection switching circuitry of the SONET uplink interface adjacent the fault, which receives the failed working Rx signal, will detect a signal failure and insert the appropriate fault code into the unused overhead transport bytes (e.g., timeslots of the D10 byte) of the STS-1 signal communicated as part of an ingress signal to the switch card 106″. The protection switching circuitry that is integral to the switch card 106″ of this network element will recover the “remote” fault from the overhead bytes. The protection switching circuitry will generate a “remote” fault code that represents this remote fault as well as “local” fault codes, analyze the “remote” and “local” fault codes, and generate K1 and K2 bytes for APS channel communication around the ring in the direction opposite the fault. The protection switching circuitry also analyzes the received K1/K2 bytes to ascertain if it in fact adjacent the fault. If so, the protection switching circuitry automatically determines that the loop-back protection switching operation is to be made, and the switch fabric update logic 183 cooperates with the switch fabric control logic 158 to effectuate an update to the connections made by the switch fabric 157 in accordance with the desired switching operation.

In the BLSR/2 redundancy configuration, when the protection switch is required, the switch fabric 157 for each network element adjacent the fault is automatically controlled to loop back the operational “working” ingress channel to the output port corresponding to the “protection” egress channel that is transported in the opposite direction while also looping back the “protection” ingress channel to the output port corresponding to the “working” egress channel that is transported in the opposite direction at the given network element. These loop-backs are illustrated in FIG. 4B. In the event of a failure of a network element, the network elements adjacent the failed network element perform such loop-back operations and also squelch the working group and protection group ingress signal demand that is to be dropped by the failed network element, if any. These operations are performed on a per-line basis and thus are performed for all paths that correspond to the failed line. In order to allow the network elements of the ring to determine whether a given network element is adjacent the detected fault, the network elements adjacent the failure originate APS messages, which are forwarded by the other network elements around the ring in a well know manner as set forth in U.S. Pat. No. 5,442,620 to Kremer, herein incorporated by reference in its entirety. The network elements utilize the ring map to identify that an incoming APS message pertains to a failed segment or node adjacent thereto. If this condition is satisfied, the appropriate loop-back and possibly squelching operations are performed. If not, the APS message is forwarded on to the adjacent network element in the ring.

In order to support the BLSR/2 protection scheme, the SONET signal processing blocks of the switch card 106″ extract K1/K2 transport overhead bytes for the STS-1 signal that is part of the ingress signals supplied thereto. In the absence of section-level or line-level faults, the K-byte Processing logic of the switch card 106″ forwards the received K bytes to Inband O/H insertion logic that inserts the K-bytes into the appropriate time slots in the egress signals supplied to the SONET uplink interfaces. Preferably, the forwarding operation of the K-byte Processing logic is enabled by software executing on the processor 177 of the switch card 106″ to support K-byte pass-thru for BLSR ring protection schemes. Note that detailed descriptions of exemplary K-byte forwarding operations carried out by the protection switching circuitry are set forth below with respect to FIG. 9.

The Fault Processing block of the switch card 106″ also monitors other portions of the overhead transport bytes (e.g., timeslots 7-12 of the D5 byte, timeslots 7-12 of the D6 byte, and timeslots 7-12 of the D7 byte). These bytes are used as an inband communication channel to communicate the ring map and squelch tables for the network elements of the ring. The processor 177 stores and updates the ring map and squelch table for the network element. This information is used to configure the fault processing and K-byte processing operations as described above.

In order to support BLSR/2 protection, the processor 177 of the switch card 106″ also executes a BLSR state processing routine that carries out advanced configuration operations, such as automatic payload configuration as described herein.

For redundancy purposes, the node may utilize redundant switch cards. In such a configuration, the processor 177 of the switch card 106″ may be adapted to communicate a “Do-Not-Listen” (DNL) bit over an inband communication channel to the appropriate uplink interface. The DNL bit provides an indication that the SONET uplink interface should select data from the other switch card.

Turning now to FIG. 8, there is shown a functional block diagram of exemplary protection switching operations carried out by the hardware-based fault processing block 129 and programmed processor 127 of FIG. 5B. The line-level and path-level faults (labeled 801) are forwarded from the SONET framer (FIG. 5B) to dedicated hardware block 803. These faults are typically automatically output from the SONET framer in one of many different ways (e.g., as part of E1/F1/E2 overhead bytes communicated from the SONET framer or as part of a SARC message communicated from the SONET framer). These faults typically indicate at the following conditions: system failure, Loss of Signal (LOS), Out of Frame Alignment (OOF), Loss of Frame (LOF), Alarm Indication Signal-Line (AIS-L), and Alarm Indication Signal-Path (AIS-P). The dedicated hardware block 803 is adapted to cooperate with the SONET framer device to communicate these faults.

In block 803, the fault communicated by the SONET framer is translated into an appropriate fault code. Preferably, block 803 performs a table look-up operation (from the fault value supplied by the SONET framer to a corresponding fault code) based upon a table that is loaded into block 803 by a set-up/control routine 807 that is executed on the programmed processor during module initialization. This feature enables the system to be readily adapted for operation with SONET framing devices of different vendors. Currently, SONET framing devices from different vendors assign values to specific faults independently of one another. The table-look-up operation enables these disparate fault values to be converted into normalized values such that the fault processing operations carried out on the switch card are independent of the vendor of the SONET framer device.

The fault code generated at block 803 is forwarded to dedicated hardware block 805. Block 805 also interfaces to the programmed processor, which executes a control routine 807 that supplies a software-configurable fault code to block 805. Block 805 compares both incoming fault codes and forwards on the higher fault code of the two for insertion inband into the line overhead D10 bytes of the STS-1 signal recovered by the SONET framer. Note that line level faults are assigned to all constituent paths. More particularly, there are N D10 bytes per STS-N frame. These N D10 bytes are used once per STS-1 path to carry the fault code for the path as follows:

| | | | | |
|---|---|---|---|---|
| D10 byte for | D10 byte for | . . . | D10 byte for | D10 byte for |
| STS-1 path | STS-1 path | | STS-1 path | STS-1 path |
| #1 | #2 | | #N − 1 | #N |
| Path 1 Code | Path 2 Code | . . . | Path N − 1 | Path N Code |
| | | | Code | |

In this manner, fault codes on a per path basis are communicated in band within the line overhead D10 bytes from the SONET uplink interface to the switch card.

In order to support BLSR protection, the switch card processor communicates over an inband communication channel within the egress signals supplied to the SONET uplink interfaces (for example, the first 16 time slots in the D11 bytes) to inform the “head-end protect” SONET uplink interface and the “tail-end protect” SONET uplink interface to thereby configure the paths associated with a given BLSR state code. These inband bytes (e.g., certain D11 bytes) are extracted from the egress signals (at the inband overhead processing block) and communicated to the dedicated D-byte processing block 809. When these inband bytes change, the processing block 809 communicates the changes to the line terminating processor preferably utilizing an interrupt/polling interface. In this manner, the BLSR state information is communicated over the inband communication channel from the switch card processor to the line terminating processor. A BLSR state processing routine 811 executing on the line terminating processor utilizes the BLSR state information to perform advanced configuration operations, such as automatic payload configuration as described herein. Upon termination of the inband communication channel bytes (e.g., D11 bytes), the SONET framer is programmed to overwrite the appropriate D bytes with either 0x00, or a valid D byte, as it applies to Line DCC.

For a point-to-point 1:N redundancy scheme, the switch card processor may be adapted to communicate path configuration data to the appropriate uplink interfaces for the paths on the protect line at the time of the switch. Preferably, such communication occurs over an inband communication channel such as the D11 bytes of the egress signals. The SONET uplink interface recovers the path configuration data and uses it to facilitate the appropriate action.

For redundancy purposes, the node may utilize redundant switch cards. In such a configuration, the processor 177 of the switch card 106 may be adapted to communicate a “Do-Not-Listen” (DNL) bit over an inband communication channel to the appropriate uplink interface. In such configuration, the SONET uplink interfaces recovers the DNL bit, and operates upon its reception to select data from the other switch card.

Turning now to FIG. 9, there is shown a functional block diagram of exemplary protection switching operations carried out by the hardware-based fault processing block 181, hardware-based K-byte processing block 185, and programmed processor 177 of FIG. 5C. The section-level faults (labeled 901) are forwarded from the SONET processing circuitry to dedicated hardware block 903. These faults may be automatically output from the SONET processing circuitry in one of many different ways (e.g., as part of E1/F1/E2 overhead bytes communicated from the SONET processing circuitry, as part of a SARC message communicated from the SONET processing circuitry, or other suitable means). These faults typically indicate section level faults including at the following conditions: system failure, Loss of Signal (LOS), Out of Frame Alignment (OOF), Loss of Frame (LOF), B1 error—Signal Fail, B1 error—Signal Degrade. The dedicated hardware block 903 is adapted to cooperate with the SONET signal processing blocks (FIG. 5C) to communicate these faults.

In block 903, the fault communicated by the SONET signal processing block is translated into an appropriate fault code. Preferably, block 903 performs a table look-up operation (from the fault value supplied by the SONET signal processing block to a corresponding fault code) based upon a table that is loaded into block 903 by a set-up/control routine 907 that is executed on the programmed processor (FIG. 5C) during module initialization. This feature enables the Network Element to be readily adapted for operation with SONET signal processing devices of different vendors as set forth above. Note that the fault code generated by block 903 is a “local fault code”, in that it represents inter-module synchronization problems and other internal failures that might occur within the Network Element itself.

The local fault code generated at block 903 is forwarded to dedicated hardware block 905. Block 905 also interfaces directly to dedicated hardware block 909 and indirectly to dedicated hardware block 907. The SONET signal processing circuitry automatically outputs all ingress D-bytes extracted from the ingress signal.

Block 907 monitors the ingress D-bytes output by the SONET signal processing blocks and extracts all relevant portions that are used for inband communication (e.g., D5-D7 and D10 bytes). On a change in certain overhead byte portions (e.g., a change in time slots 2-4 and 7-12 of D5, time slots 7-12 of D6 and time slots 7-12 of D7), block 907 interrupts the programmed processor, and allows the programmed processor to poll for the current value of these D-byte portions. As described above, these byte portions are used as an inband communication channel to communicate the ring map and squelch tables for the network elements of the ring. The processor 177 utilizes the interrupt/polling interface to store and update the ring map and squelch table for the network element. This information is used to configure the fault processing and K-byte processing operations carried out by the circuitry as described herein.

Block 907 also forwards all D10 bytes to block 909, which passes the remote inband fault code contained therein to block 905. As described above, there are N D10 bytes per STS-N frame. These N D10 bytes are used once per STS-1 path to carry the fault code for the path as follows:

| | | | | |
|---|---|---|---|---|
| D10 byte for | D10 byte for | . . . | D10 byte for | D10 byte for |
| STS-1 path | STS-1 path | | STS-1 path | STS-1 path |
| #1 | #2 | | #N − 1 | #N |
| Path 1 Code | Path 2 Code | . . . | Path N − 1 | Path N Code |
| | | | Code | |

Block 905 compares the local fault code received from block 903 and the remote fault code received from block 909, and forwards the higher of the two fault codes to block 911. The highest code value is also forwarded to K-byte processing block 951 described below.

Dedicated hardware block 911 debounces the fault code supplied thereto by block 905 for 1-3 frames to thereby introduce hysteresis in the fault code analysis. Such hysteresis (debouncing) aids in preventing invalid protection switch toggling on transient glitches. The debounced fault code is forwarded to block 913. Block 911 also preferably generates an interrupt on a change of a debounced fault code for a given path, and allows the fault processing setup routing executing on the processor to poll for the current debounced fault code on a per STS-1 basis.

Dedicated hardware Block 913 compares the debounced fault code from block 911 to a fault code supplied by the fault processing/control routine executing on the programmed processor, and forwards on the higher of the two fault codes to block 915. These operations enable software-based fault code insertion and user initiated commands after fault code debouncing to support generation of “protection switch notifications” for fault codes arriving while a fault (e.g., LOP, FSW, FSP) is in place. Note that certain fault codes (e.g., LOP, FSW, FSP) can be static codes that remain in place as long as any user command is present, and thus cannot be preempted by any detected faults (“local” or “remote”).

Moreover, certain user-initiated (e.g., manual switch for working (MSW) command and manual switch for protection (MSP) command) must be cleared by the software routine before forwarding a fault code of higher priority.

Dedicated hardware block 915 receives fault codes from block 913. The fault codes received at this point are unique to a given defect, which creates several instances where the fault codes overlap with each other in the various protection switching schemes. Block 915 analyzes the received fault codes to filter and group relevant defects, and outputs a fault code on a per path basis to block 917. Preferably, this is accomplished with the use of a look-up table that performs such filtering and grouping operations. The look-up table is configured for the particular protection scheme implemented by the Network Element and is supplied to the hardware block 915 by the control routine executing on the processor upon initialization or changes in the protection scheme configuration.

For example, when a point-to-point 1+1 redundancy scheme is used, the look-up table provisioned by the programmed processor filters out all defects except line-level defects.

For UPSR protection schemes, the look-up table converts all line-level fault codes (with the exception of Line BERH and BERL) to the equivalent path-based P-AIS code, and then groups all path codes. The look-up table also preferably maps local fault codes to equivalent line-based SF fault codes for point-to-point 1+1 or BLSR configurations or to equivalent path-based P-AIS faults for UPSR configurations. In this manner, the hardware block 917 is configured to group fault codes in accordance with a particular protection scheme and filter out codes that do not apply to the particular protection scheme.

Dedicated hardware block 917 provides a hardware timer that is configurable between 50 and 100 ms on a per path basis via the setup/control routine executing on the programmed processor. The timer is enabled for BLSR protection schemes on the onset of a BLSR switch, and disabled for other schemes. The purpose of this timer is to inhibit all switching decisions on path level defects until the timer expires. This features aids to prevent unwanted protection switches on potentially transient defects. When the timer is disabled, the fault code supplied by block 915 is passed thru to block 919 without delay. When the timer for a particular path is enabled, the fault code supplied by block 915 for the particular path is inhibited until the timer expires. Upon expiration, the current fault code is forwarded onto block 919.

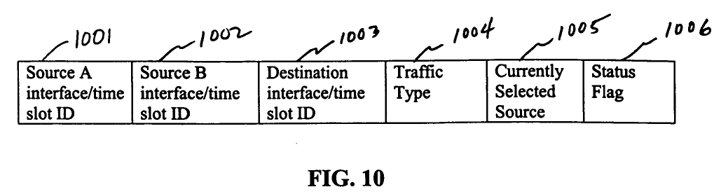

Dedicated hardware block 919 determines the appropriate connection changes of the switch fabric in accordance with the path-level fault code supplied by block 917. Preferably, this operation utilizes a selector table that includes an array of entries each having a logical organization as shown in FIG. 10. The table entry includes three fields 1001, 1002, 1003 each storing an integer value that represents a particular interface/time slot of the node. The first field 1001 (labeled “Source A interface/time slot”) and the third field 1003 (labeled “Destination interface/time slot”), collectively, represent a first path through the node, while the second field 1002 (labeled “Source B interface/time slot”) and the third field 1003 (labeled “Destination interface/time slot”), collectively, represent a second path through the node. In this manner, each entry represents two alternative paths through the node. Field 1005 identifies the current selected path/source. This field is automatically updated by the source selector logic 919 in the event that the source selector logic 919 makes a decision to select the alternate ingress source as described below. Field 1006 is a status flag that indicates the change in the selected path/source since the last access by the software-based control routine 907.

The selector table entries are configured by the setup/control routine 907 executing on the programmed processor in accordance with the protection scheme implemented by the system. Block 919 allows the software-based routine to poll block 919 for the currently selected path on a per selector basis. In this manner, the destination interface/time slot (e.g., outgoing channel number) is configured on a per path (table entry) basis. Moreover, software-based configuration of the traffic size associated with each path (table entry) allows the selector logic 919 to account for all STS-1s when switching concatenated payloads.

The path level fault codes output by timer 917 are supplied to the auto source selector logic 919. Upon receipt of a path level fault code, the selector logic 919 accesses the entry corresponding to the path of the fault code, compares the fault codes for the two paths represented the entry, and cooperates with the connection map update logic 923 to automatically switch to the path with the lesser of the two fault codes. When the two fault codes are equal, the logic 919 does not switch the path from the current selection. In this manner, the logic 919 can automatically issue connection change commands to the TDM switch fabric control without software intervention, which is particularly advantageous in LAPS and UPSR protection switching schemes. Preferably, the selector logic 919 can be enabled/disabled under control of the control routine 907 on a per path (table entry) basis.

A post switch timer block 921 provides a software-configurable timer that cooperates with block 919 to prevent automatic switch oscillations and provide a delay period for the setup/control routine executing on the processor to evaluate the protection switch. The time-out value is software configurable on a per path basis by the programmed processor. Block 919 sends an event signal to the timer block 921 that a protection switch operation for a particular path is underway. Upon receiving this event signal, the timer block 921 returns a disable event signal that disables the switching operation for the particular path, and then starts the timer for the particular path. When the timer expires, block 921 communicates an enable event signal to block 919 that allows the protection switch operation to proceed, whereby block 919 communicates with connection map update block 923.

Dedicated hard block 923 is responsible for communicating with the control circuitry of the switch fabric to update the connections made by the switch fabric in accordance with the automatic switch selection determined by block 919, or possibly a software-controlled switch update invoked by a switch control routine 925 executing on the programmed processor. Preferably, block 923 implements a hardware semaphore that updates the connection map memory of the switch fabric, thereby avoiding contention between software-controlled connection map memory updates and hardware-controlled connection map memory updates. In this configuration, the software-based routine 925 does not directly update the connection map memory of the switch fabric. Instead, it first disables hardware-based updates by setting a disable flag. It then cooperates with block 923 to communicate its desired updates to the connection map memory. Finally, it raises an enable flag that allows block 923 to perform the desired SW-invoked updates communicated thereto. Hardware-based updates are disabled when the disable flag is set in order to prevent a contention condition whereby a software-based update is being performing while a hardware-based update makes a change to the connection map (e.g., different entries) and makes the change effective before the software-based update is complete. Preferably, block 923 generates an interrupt for each hardware-based connection map update. The switch control routine can process the interrupt and look for hardware-based connection map updates by reading (polling) the entries in the selector table of block 919.

A software-based wait-to-restore timer 927 is set for a fixed duration upon determining that all faults (including line faults as well as path faults in path-based protection schemes) have cleared. The fixed duration is a user-configured value. When the wait-to-restore timer is set, a software-inserted fault code is provided to block 915 by the control routine 906. Upon expiration of the timer, this software-based fault code is cleared by block 915, which causes the source selector 919 and connection map update logic 923 to restore the connection to the original working or preferred source, unless such operations are preempted (cancelled) upon detection of a new incoming fault. In this manner, the wait-to-restore timer is automatically/immediately preempted (cancelled) upon the detection of a new incoming fault.

In order to support BLSR protection schemes as described above, the SONET signal processing blocks of FIG. 5C extracts the K1/K2 transport overhead bytes for the STS-1 signal that is part of the ingress signals supplied thereto. These K1/K2 overhead bytes are supplied to dedicated hardware logic block 951, which forwards such K1/K2 bytes to K-byte debounce block 953 in the absence of section-level or line-level faults. Section-level and line-level faults are preferably dictated by comparing the fault code output by block 905 to a software-configured line fault base code value. In this configuration, the software-based K1/K2 byte processing setup/control routine 955 configures to line fault base code to ensure that it is higher than line BER errors but less than fault codes related to LOS, LOF and OOF. The K-byte debounce block 953 debounces the K bytes supplied thereto by block 951 for 1-3 frames to thereby introduce hysteresis in the K-byte processing. The number of frames (in the range between 1 and 3) for the debounce is preferably selectable by software, and is set to a default value of 3. Block 953 monitors changes in the debounced K-byte values. When a change occurs, block 953 raises an interrupt, and the K-byte control routine is presented with the debounced K-byte value via polling block 953. Under line fault conditions, which are dictated either by remote fault codes or local fault codes, block 951 supplies the most recent debounced K bytes prior to the line fault. The changes to the debounced K-byte values are analyzed by the software-based K byte control routine 955 in accordance with the requirements of the BLSR redundancy scheme configuration of the network element as described herein.

K-byte forwarding block 957 provides for the forwarding of K bytes in a pass-thru mode for BLSR configurations. In such configurations, the node ID for the network element is configured at runtime and stored by the programmed processor. This node ID presents a unique node identifier in a BLSR ring configuration. The incoming K bytes are forwarded by block 951 to the K-byte forwarding logic 957. The destination node (bits 5-8 of the K1 byte) is compared with the unique node ID assigned to the network element. A mismatch between these two node IDs indicates that the extracted K-bytes are destined for a remote node. Such K bytes are forwarded to the Egress K byte buffer 959 for insertion into the K bytes transport overhead of the egress signal stream. If the destination node matches the unique node ID assigned to the network element, or the K-bytes are zero and thus invalid), the K-bytes are discarded and not forwarded to the Egress K Byte buffer 959. Preferably, block 957 allows for the software-based control routine 955 to enable/disable the K byte forwarding mechanism on an outgoing line interface basis.

The Egress K byte buffer 959 stores a K byte forwarding map that facilitates in selecting the appropriate time slot in the egress direction. The K byte forwarding map is based on the routing configuration and is setup by control routine 955. Preferably, the K byte forwarding map is a pairing of line interfaces that indicate that, once of set of K bytes on a particular incoming line satisfy a forwarding criteria, these K-bytes are inserted verbatim into the configured outgoing line interface. The K byte forwarding map is bidirectional in the sense that line pairings forward their eligible K bytes to each other in both directions.

The K-byte processing blocks 951, 953, 957, 959 described above are utilized in BLSR ring protection configurations. Preferably, such blocks are enabled by the control routine 925 only for BLSR configurations. In the 1+1 and UPSR redundancy schemes, these blocks are preferably disabled.

The programmed processor on the switch card preferably executes a control routine 961 that generates egress D bytes in support of the various protection switching schemes. When the node is configured for BLSR protection switching and a protection switch is initiated, the control routine 961 cooperates with the inband overhead insertion block on the switch card to communicate over an inband communication channel (for example, certain time slots in the D11 bytes) to inform the “head-end protect” SONET uplink interface and the “tail-end protect” SONET uplink interface to thereby configure the paths associated with a given BLSR state code. These uplink interfaces will recover such BLSR state information and utilize the BLSR state information to perform advanced configuration operations, such as automatic payload configuration as described herein.

For a point-to-point 1:N redundancy scheme, the programmed processor on the switch card may be adapted to communicate dynamic path configuration data to the appropriate uplink interfaces for the paths on the protect line at the time of the switch.

For redundancy purposes, the node may utilize redundant switch cards. In such a configuration, the programmed processor of the switch card may be adapted to communicate a “Do-Not-Listen” (DNL) bit over an inband communication channel to the appropriate uplink interface. The DNL bit provides an indication that the uplink interface should select data from the other switch card.

The egress D-bytes generated by the control routine 961 are also used as an inband communication channel (e.g., timeslots #2-4 of the D5 byte, and time slots #7-12 of the D5 byte, D6 byte, and D7 byte on a per line basis) to communicate the ring map and squelch tables for the network elements of the ring in support of the various automatic protection switching schemes.

The functionality of the Network Element as described herein can be realized as part of an Add/Drop Multiplexer, Digital Cross-Connect System, a Multi-Service Access System (for example, an MPLS Access System that supports an array of digital data formats such as 10/100 Ethernet, Gigabit Ethernet, 10 Gigabit Ethernet, Frame Relay, etc. and transports such digital data over a SONET transport network) and the like. Note that in alternate embodiments of the present invention, the SONET overhead processing and termination functionality for the SONET uplink interfaces of the Network Element can be realized by a multi-channel SONET framer device. In this configuration, the multi-channel SONET framer device typically interfaces to a plurality of SONET physical line ports. The multi-channel SONET framer device performs SONET overhead processing and termination functionality for the plurality of SONET signal channels communicated over the ports. The multi-channel SONET framer also typically multiplexes the plurality of received SONET signal channels into a higher order signal (or other suitable format signal) for communication over the back plane to the switch card. It also demultiplexes these higher order signals (or other suitable format signal) into a number of lower order SONET signal channels for the multi-channel processing prior to transmission over the physical ports coupled thereto.

It is also possible that the insertion of the inband transport overhead bytes at the SONET Uplink interface and/or at the switch card can be realized as part of the functionality provided by the SONET overhead processing and termination device used therein. In this configuration, the protection switching circuitry that performs this overhead byte insertion function (e.g., block 131, block 135 and block 187) can be omitted and replaced with circuitry that interfaces to the SONET overhead processing and termination device used therein to accomplish this function.

Advantageously, the SONET Network elements of the present invention include automatic protection switching circuitry that is located at a centralized decision-making point in the system, for example integrated with the TDM switching fabric on a switch card or board. The network elements detect line and path faults at the line interface unit(s) of the system and-communicate fault codes that describe such faults over an inband overhead byte communication channel to the central decision making location, thereby impose no additional bandwidth requirements between the line interface unit(s) and the central decision-making point. The automatic protection switching circuitry is realized by a combination of dedicated hardware blocks (e.g., FPGA, ASIC, PLD, transistor-based logic and possibly embedded memory in system-on-chip designs) and a programmed processing system. The functionality realized by the dedicated hardware blocks (fault processing, switch fabric update, K-byte processing, etc) can be readily adapted to meet the bandwidth and computational requirements for large systems at reasonable costs. The software-based processing system provides for programmability and user control over the operations carried out by the dedicated hardware, for example providing for user-initiated commands that override the automatic protection switching operation that would be normally carried out by the dedicated hardware.

There have been described and illustrated herein several embodiments of automatic protection switching (APS) circuitry for a network node. While particular embodiments of the invention have been described, it is not intended that the invention be limited thereto, as it is intended that the invention be as broad in scope as the art will allow and that the specification be read likewise. Thus, while particular system-level, card-level, and channel-level functional partitioning has been disclosed, it will be appreciated that the circuitry of the present invention can be readily adapted to systems that employ different architectures. Furthermore, while particular SONET based redundancy schemes have been discussed, it will be understood that the APS circuitry of the present invention can be readily adapted for use in other redundancy schemes. It will therefore be appreciated by those skilled in the art that yet other modifications could be made to the provided invention without deviating from its spirit and scope as claimed.

What is claimed is:

1. Electronic circuitry for controlling automatic switching of a network element that receives and transmits SONET signals, said electronic circuitry comprising:
dedicated hardware logic that includes the following:
a first part that is adapted to extract fault codes carried in predetermined overhead bytes that are part of said SONET signals;
a second part that is adapted to generate fault codes that represent inter-module communication errors within the network element;
a third part that determines switch fabric configuration updates based upon the fault codes generated by the first block and the second block; and
a fourth part that communicates with switch fabric control logic to carry out the switch fabric configuration updates determined by the third block; and
a programmed processor that is adapted to automatically configure and control the first, second, third and fourth parts in accordance with software executing on the programmed processor to carry out a selected one of a plurality of automatic protecting switching schemes configured by operation of said programmed processor.

2. The electronic circuitry according to claim 1, wherein:
said third part comprises a fault code analysis block that analyzes the fault codes extracted by the first part to determine the fault code with highest priority.

3. The electronic circuitry according to claim 2, wherein:
said programmed processor and dedicated hardware are adapted to provide for software-based fault code insertion for analysis by the fault-code analysis block.

4. The electronic circuitry according to claim 1, wherein:
said third part comprises a fault code processing block that filters fault codes that do not pertain to a selected automatic protection switching scheme configuration, and that converts fault codes to group fault codes that pertain to the selected automatic protection switching scheme configuration.

5. The electronic circuitry according to claim 4, wherein:
said programmed processor and dedicated hardware are adapted to provide for software-based configuration of the fault code filtering and fault code grouping operations carried out by said fault code processing block.

6. The electronic circuitry according to claim 1, wherein:
said dedicated hardware further comprises a block for extracting K1 and K2 bytes that are part of said SONET signals.

7. The electronic circuitry according to claim 6, wherein:
said dedicated hardware further comprises a block that communicates K1 and K2 bytes to said programmed processor.

8. The electronic circuitry according to claim 6, wherein:
said dedicated hardware further comprises a K-byte forwarding block that forwards K1 and K2 bytes as part of the transport overhead of an egress signal.

9. The electronic circuitry according to claim 8, wherein:
said programmed processor and dedicated hardware are adapted to provide for software-based control over the forwarding operations carried out by said K-byte forwarding logic.

10. The electronic circuitry according to claim 1, wherein:
said dedicated hardware further comprises a block that recovers predetermined transport overhead bytes that communicate ring map information and squelch table information from other network elements, and that communicates such transport overhead bytes to said programmed processor.

11. The electronic circuitry according to claim 10, wherein:
said programmed processor generates predetermined transport overhead bytes that communicate ring map information and squelch table information to other network elements.

12. The electronic circuitry according to claim 11, wherein:
said dedicated hardware receives said predetermined overhead bytes from said programmed processor and inserts said predetermined overhead bytes into an egress signal for communication to other network elements.

13. The electronic circuitry according to claim 1, wherein:
said programmed processor generates at least one predetermined transport overhead byte that communicates BLSR state data to a line interface of the network element.

14. The electronic circuitry according to claim 13, wherein:
said dedicated hardware receives said at least one predetermined transport overhead byte from said programmed processor and inserts said at least one predetermined overhead byte into an egress signal for communication to the line interface of said network element.

15. The electronic circuitry according to claim 1, wherein:
said third part includes selector logic that utilizes a table of entries to automatically determine switch fabric configuration updates based upon said fault codes and that automatically communicates said switch fabric configuration updates to said fourth part.

16. The electronic circuitry according to claim 15, wherein:
said table of entries is configured by said programmed processor.

17. The electronic circuitry according to claim 15, wherein:
said selector logic is selectively enabled on a per path basis by said programmed processor.

18. The electronic circuitry according to claim 15, wherein:
each entry of the table corresponds to a pair of paths through the network element, and said selector logic automatically generates switch fabric configuration updates that switch between the paths of a given pair corresponding to an entry based upon fault codes associated with the paths of the given pair.

19. The electronic circuitry according to claim 1, wherein:
said plurality of automatic protecting switching schemes are selected from the group including a point-to-point 1+1 scheme, a UPSR scheme, a 4-wire BLSR scheme, and a 2-wire BLSR scheme.

20. The electronic circuitry according to 1, wherein:
said dedicated hardware is realized as part of an integrated circuit comprising one of an FPGA, ASIC, PLD, and transistor-based logic for system-on-chip applications.

21. An apparatus for use in a network element having at least one interface unit, said apparatus comprising:
a switch fabric including control circuitry;
SONET signal processing circuitry, operably coupled to said switch fabric, that is adapted to operate on signals supplied from said at least one line interface to output ingress signals to said switch fabric, and operating on egress signals supplied from said switch fabric for output to said at least one interface unit;
the electronic circuitry of claim 1, operably coupled to said SONET signal processing circuitry and said control circuitry of said switch fabric, that is adapted to carry out a selected one of a plurality of automatic protecting switching schemes as configured by operation of said programmed processor.

22. The apparatus according to claim 21, wherein:
said plurality of automatic protecting switching schemes are selected from the group including a point-to-point 1+1 scheme, a UPSR scheme, a 4-wire BLSR scheme, and a 2-wire BLSR scheme.

23. The apparatus according to claim 21, wherein:
the dedicated hardware of said electronic circuitry is realized as part of an integrated circuit comprising one of an FPGA, ASIC, PLD, and transistor-based logic for system-on-chip applications.

24. The apparatus according to claim 21, wherein:
the electronic circuitry of claim 1 is integral with the switch fabric and SONET signal processing on a printed circuit card.

25. The apparatus according to claim 21, wherein:
the electronic circuitry of claim 1 is integral with the switch fabric and SONET signal processing as part of a system-on-a-chip.

26. A network element comprising:
at least one interface unit;
a switch fabric including control circuitry;
SONET signal processing circuitry, operably coupled to said switch fabric, that is adapted to operate on signals supplied from said at least one line interface to output ingress signals to said switch fabric, and operating on egress signals supplied from said switch fabric for output to said at least one interface unit;
the electronic circuitry of claim 1, operably coupled to said SONET signal processing circuitry and said control circuitry of said switch fabric, that is adapted to carry out a selected one of a plurality of automatic protecting switching schemes as configured by operation of said programmed processor.

27. The network element of claim 26, wherein:
said line interface is adapted to communicate fault information utilizing an inband communication channel that operates over predetermined overhead transport bytes that are part of signals communicated to said SONET signal processing circuitry.

28. The network element of claim 26, wherein:
said plurality of automatic protecting switching schemes are selected from the group including a point-to-point 1+1 scheme, a UPSR scheme, a 4-wire BLSR scheme, and a 2-wire BLSR scheme.

29. The network element according to 26, wherein:
the dedicated hardware of said electronic circuitry is realized as part of an integrated circuit comprising one of an FPGA, ASIC, PLD, and transistor-based logic for system-on-chip applications.
